(19) United States
(12) Patent Application Publication
(10) Pub. No.: US 2014/0352654 A1
(43) Pub. Date: Dec. 4, 2014

(54) Rotary Wing Engine

(71) Applicant: Rotary Wing Engine, Inc., San Jose, CA (US)

(72) Inventor: Simon E. Saba, San Jose, CA (US)

(73) Assignee: Rotary Wing Engine, Inc., San Jose, CA (US)

(21) Appl. No.: 14/209,809

(22) Filed: Mar. 13, 2014

Related U.S. Application Data
(60) Provisional application No. 61/785,859, filed on Mar. 14, 2013.

(51) Int. Cl. F02B 53/02

(52) U.S. Cl. CPC F02B 53/02; F02B 2730/016
USPC 123/200

(57) ABSTRACT

Embodiments relate to a rotary internal combustion engine with a sealing structure that enables a rotor and a plurality of wings within a housing to form a plurality of sealed chambers. The wings are connected to the rotor and can rotate about a first axis with reference to the rotor, and the rotor can rotate about a second axis with reference to the housing, the second axis parallel to the first axis. As the rotor rotates within the housing, the wings follow a predefined path, causing the sealed chambers to change in volume. In some embodiments, each sealed chamber undergoes the intake, compression, power, and exhaust cycles of a four stroke engine.

### CROSS REFERENCE TO RELATED APPLICATIONS

This application claims the benefit of priority under 35 U.S.C. §119(e) to U.S. Provisional Application No. 61/785,859 filed Mar. 14 2013, which is incorporated by reference herein in its entirety.

### BACKGROUND

1. Field of Art

The disclosure generally relates to the field of internal combustion engines. Specifically, this disclosure relates to rotary engines with pistons pivotally mounted on a rotating rotor.

2. Description of the Related Art

Internal combustion engines are used in a variety of different applications, ranging from automobiles to aircraft to lawn mowers. Traditional internal combustion engines are relatively energy inefficient, converting approximately 70% of the fuel's energy into waste heat. This waste heat leads to high operating temperatures which causes premature component failure.

Traditional piston-based internal combustion engines are also difficult to package in a compact form factor, as each piston requires a corresponding cylinder, intake and exhaust valves, sparkplug, and connecting rod. Finally, traditional piston-based internal combustion engines are susceptible to excess vibration and noise due to the fact that each piston reciprocates rapidly without being counterbalanced. Therefore, there is a need for an internal combustion engine that can be cooled more efficiently, can be packaged in a more compact form factor, and is less susceptible to vibration and noise.

### SUMMARY OF THE INVENTION

Embodiments relate to a rotary internal combustion engine including a housing, a rotor, a plurality of wings, and a plurality of sealing structures. The housing extends longitudinally along a first axis and includes a cylindrical internal surface. The housing is formed with an intake port and an exhaust port. The rotor is positioned inside the housing to rotate about the first axis and includes a plurality of arms extending to the cylindrical internal surface. Each of the wings is attached to each of the arms to rotate with reference to the rotor along a second axis parallel to the first axis. Each of the sealing structures is mounted onto each of the wings. The sealing structure isolates a first space between the cylindrical internal surface and each of the wings from a second space between each of the wings and the rotor. Combustible gas is received in the first space through the intake port for ignition, and exhaust gas is discharged from the first space through the exhaust port.

In some embodiments, the rotary internal combustion engine encloses structures at both ends of the housing and configured to enclose the rotor and the wings within the housing.

In some embodiments, the enclosing structures include flat cylindrical end plates that are secured to each end of the housing.

In some embodiments, tubes are formed within the shell and the enclosing structures, the tubes configured to circulate cooling fluid to cool the rotary combustion engine.

In some embodiments, each arm of the rotor comprises a curved surface abuts the sealing structure of a corresponding wing. The curved surface has a radius of curvature corresponding to a distance from the second axis of the wing to a leading edge of the wing facing the surface. The sealing structure slides along the curved surface.

In some embodiments, each of the wings further includes an outer surface extending from the leading edge. The outer surface having a radius of curvature the same as the internal cylindrical surface.

In some embodiments, the sealing structure includes a first member, and a second member. The first member abuts the curved surface. The first member extends across a first length and has a first width shorter than the first length. The first member includes a first sub-member, a second sub-member and a first bridge. The first sub-member extends across the first length. The second sub-member extends across the first length in parallel to the first sub-member. The first bridge connects the first sub-member and the second sub-member. The bridge in conjunction with the second sub-member forms a cantilever structure to provide resilience to the first member in a direction of the width of the first member. The second member intersects with the first member to form an angle with respect to the first member. The second member has a second length and a second width shorter than the second length. The second member includes a third sub-member, a fourth sub-member and a second bridge. The third sub-member extends across the second length. The fourth sub-member extends across the second length in parallel to the third sub-member. The second bridge connects the third sub-member and the fourth sub-member. The second bridge in conjunction with the fourth sub-member forms a cantilever structure to provide resilience to the second member in a direction of the width of the second member.

In some embodiments, the rotary internal combustion engine further includes a sparkplug extending through a sparkplug hole formed in the housing.

In some embodiments, grooves are formed in the cylindrical internal surface of the shell extending from the sparkplug hole.

In some embodiments, the housing further includes a plurality of cooling fins extending outward from the housing.

In some embodiments, the rotary internal combustion engine further includes an enclosing structure attached to one end of the housing with the rotor and the wings enclosed in interior of the housing. A cam track is formed in the enclosing structure to constrain the rotation of the wings with reference to the rotor as the rotor rotates about the first axis.

In some embodiments, the cam track is isolated from the first space during the ignition of the combustible gas during the operation of the rotary internal combustion engine.

In some embodiments, each of the wings further includes a leading edge, a trailing edge section, an outer surface and an inner surface. The leading edge facing a corresponding arm of the rotor. The trailing edge section hinged to another arm of the rotor adjacent to the corresponding wing. The outer surface has a radius of curvature the same as the cylindrical inner surface of the shell and extending from the leading edge to the trailing edge section. The outer surface defines the first space in conjunction with the cylindrical internal surface. The inner surface extends from the leading edge to the trailing edge section. The inner surface defines the second space in conjunction with the rotor.

In some embodiments, the trailing edge section includes a trailing surface contacting the cylindrical internal surface. The trailing surface has a radius of curvature corresponding to a distance from the second axis to the cylindrical internal surface.

In some embodiments, each of the housing, rotor, and the wings are manufactured using an extrusion process.

Embodiments also relate to a sealing structure including a first member and a second member. The first member extends across a first length and has a first width shorter than the first length. The first member includes a first sub-member, a second sub-member and a first bridge. The first sub-member extends across the first length. The second sub-member extends across the first length in parallel to the first sub-member. The first bridge connects the first sub-member and the second sub-member. The bridge in conjunction with the second sub-member forms a cantilever structure to provide resilience to the first member in a direction of the width of the first member. The second member intersects with the first member to form an angle with respect to the first member. The second member has a second length and a second width shorter than the second length. The second member includes a third sub-member, a fourth sub-member and a second bridge. The third sub-member extends across the second length. The fourth sub-member extends across the second length in parallel to the third sub-member. The second bridge connects the third sub-member and the fourth sub-member. The second bridge in conjunction with the fourth sub-member forms a cantilever structure to provide resilience to the second member in a direction of the width of the second member.

In some embodiments, the second member includes a fifth sub-member that is received in a groove formed in a wing of a rotary internal combustion engine.

In some embodiments, the second member is curved in a direction perpendicular to the width of the second member.

Embodiments also relate to a method of operating a rotary internal combustion engine. A volume of a first space between a wing and an internal cylindrical surface of a housing is increased to receive combustible gas in the first space by rotating a rotor about a first axis within a housing. The volume of a second space between the wing and the rotor is decreased by rotating the wing about a second axis parallel to the first axis with the first space isolated from the second space by a sealing structure. The volume of the first space is decreased to compress the received combustible gas. The combustible gas received in the first space is ignited to exert force on the wing and form exhaust gas, responsive to decreasing the volume of the first space. The volume of the first space is increased responsive to igniting the combustible gas. The volume of the first space is decreased by rotating the wing about the second axis to discharge the exhaust gas from the first space, responsive to igniting the combustible gas. The volume of the second space is decreased by rotating the wing about the second axis with the first space isolated from the second space by the sealing structure.

In some embodiments, contact between a trailing edge section of the wing and the internal cylindrical surface is maintained during the rotation of the wing about the second axis.

### BRIEF DESCRIPTION OF DRAWINGS

The disclosed embodiments have advantages and features which will be more readily apparent from the detailed description, the appended claims, and the accompanying figures (or drawings). A brief introduction of the figures (Figs.) is below.

FIG. 1A illustrates an exploded perspective view of a rotary wing engine according to one embodiment.

FIG. 1B illustrates a cross-sectional view of the rotary wing engine according to one embodiment.

FIG. 2A illustrates a perspective view of an engine housing according to one embodiment.

FIG. 2B illustrates a top-down view of the engine housing according to one embodiment.

FIG. 2C illustrates a cross-sectional view of the engine housing taken along line A-B, according to one embodiment.

FIG. 2D illustrates a cross-sectional view of an engine housing with cooling pins, according to one embodiment.

FIG. 2E illustrates a cross-sectional view of the engine housing according to one embodiment.

FIG. 3A illustrates a perspective view of an end plate according to one embodiment.

FIG. 3B illustrates a front view of the end plate according to one embodiment.

FIG. 3C illustrates a rear view of the end plate with coolant paths according to one embodiment.

FIG. 4A illustrates a perspective view of a rotor according to one embodiment.

FIG. 4B illustrates a front view of the rotor of FIG. 4A, according to one embodiment.

FIG. 5A illustrates an exploded perspective view of a wing assembly according to one embodiment.

FIG. 5B illustrates a top-down view of the wing assembly according to one embodiment.

FIG. 6A illustrates a cross sectional view of the wing taken along line C-D, according to one embodiment.

FIG. 6B illustrates a cross-sectional view of the wing with cooling fins, according to one embodiment.

FIG. 6C illustrates a cross-sectional view of the wing and a hinge mechanism taken along line C-D, according to one embodiment.

FIG. 6D illustrates a cross-sectional view of the wing with an internal truss structure, according to one embodiment.

FIG. 7A illustrates a perspective view of a sealing structure according to one embodiment.

FIG. 7B illustrates a front view of the sealing structure of FIG. 7A, according to one embodiment.

FIG. 8A illustrates the intake step of a rotary wing engine according to one embodiment.

FIG. 8B illustrates the compression step of the rotary wing engine according to one embodiment.

FIG. 8C illustrates the power step of the rotary wing engine according to one embodiment.

FIG. 8D illustrates the exhaust step of the rotary wing engine according to one embodiment.

### DETAILED DESCRIPTION

The Figures (Figs.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality.

### Configuration Overview

Embodiments relate to a rotary internal combustion engine with a sealing structure that enables a rotor and a plurality of wings within a housing to form a plurality of sealed chambers. The wings can rotate about a first axis with reference to the rotor, and the rotor can rotate about a second axis with reference to the housing. The second axis is parallel to the first axis. As the rotor rotates within the housing, the wings follow a predefined path, causing the sealed chambers to increase or decrease in volume. Each sealed chamber acts as a combustion chamber in a conventional piston-based internal combustion engine and undergoes the intake, compression, power, and exhaust cycles of a four stroke engine. In some embodiments, the sealed chambers may undergo the cycles of a two stroke engine.

FIG. (FIG.) 1A illustrates an exploded perspective view of a rotary wing engine 105 according to one embodiment. The rotary wing engine 105 may include, among other components, an engine housing 110, end plates 115A and 115B (hereinafter collectively referred to as “end plates 115”), side covers 116A and 116B (hereinafter collectively referred to as “side plates 116”), a sparkplug 121, a rotor 135, a crankshaft 140, and a plurality of wing assemblies 145A through 145D (hereinafter collectively referred to as “the wing assemblies 145”). The rotary wing engine 105 has an overall cylindrical structure and may be utilized in any application that requires an internal combustion engine, such as an automobile. The rotary wing engine 105 outputs a rotational motion through the crankshaft 140. The crankshaft 140 may be connected to a driving mechanism, such as a transmission of an automobile, in order to power the automobile. In some embodiments, the crankshaft 140 may be connected to an electric motor of a hybrid drivetrain. In other embodiments, multiple rotary wing engines 105 may be stacked co-axially to increase the displacement and power output of the engine.

The wing assemblies 145 are coupled to the rotor 135 in such a way that each of the wing assemblies 145 can rotate about an axis with reference to the rotor 135, each axis parallel to the axis of the engine housing 110. The end plates 115 are secured to both ends of the engine housing 110, and the end plates 115 and engine housing 110 fully enclose the rotor 135 and wing assemblies 145. Each side cover 116 may be secured to each end plate 115. The rotor 135 is fixed to the crankshaft 140, and the rotor 135, wing assemblies 145, and crank shaft 140 can rotate about the axis of the engine housing 110 with reference to the engine housing 110 and end plates 115.

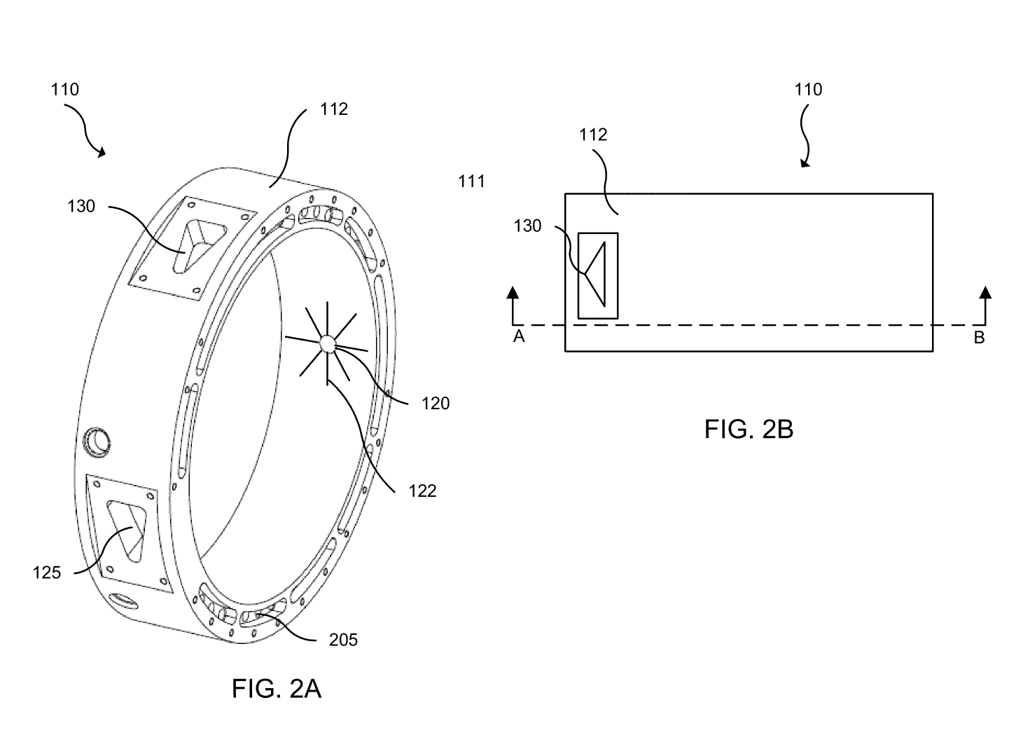

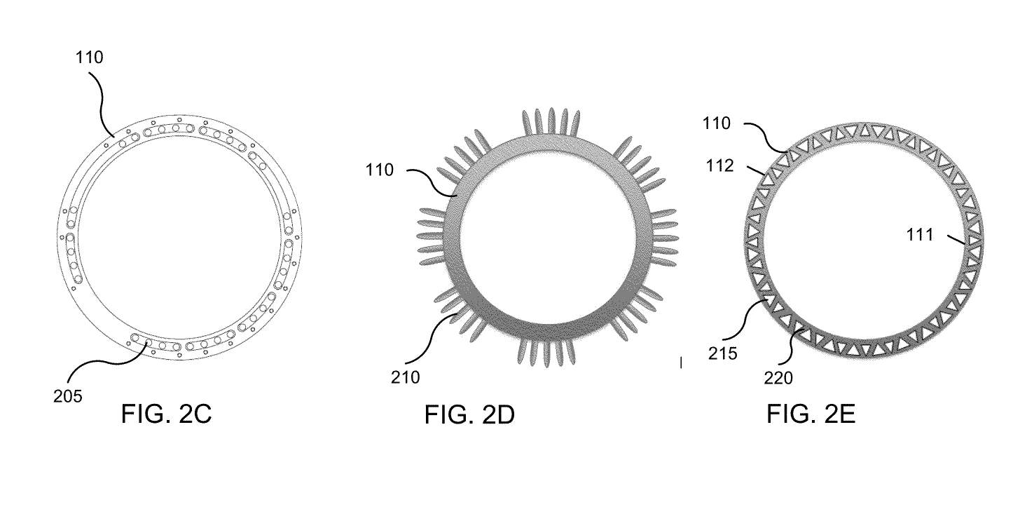

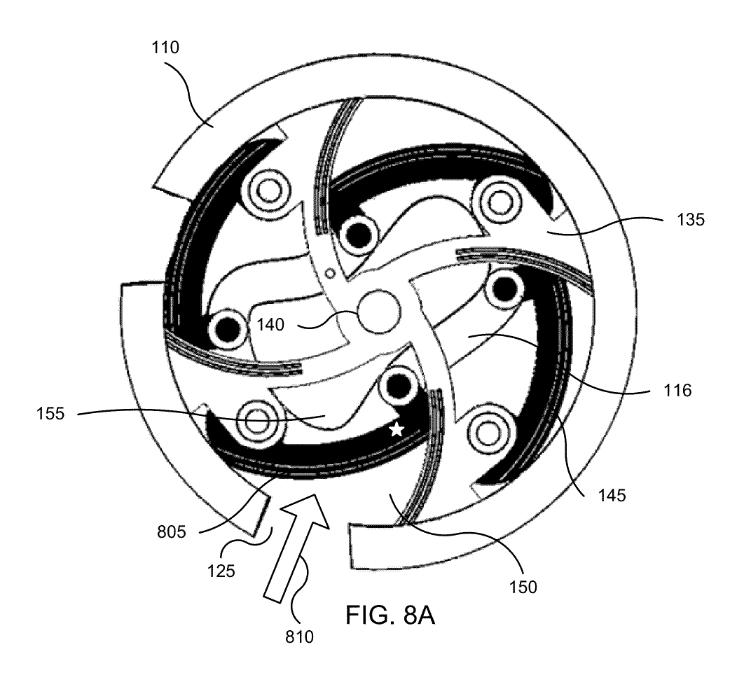

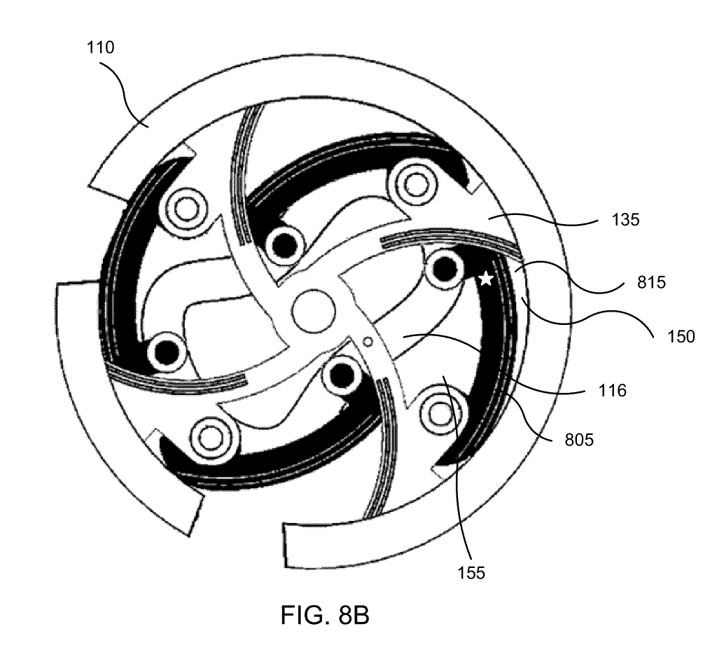

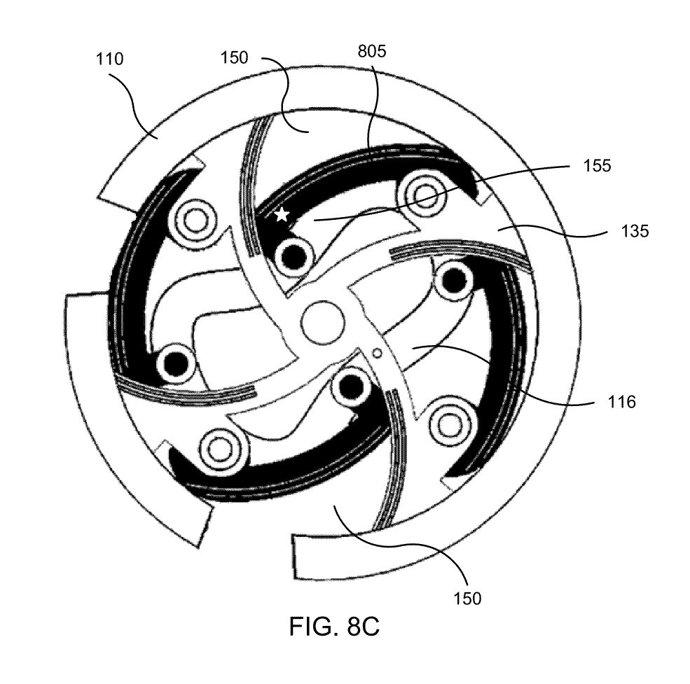

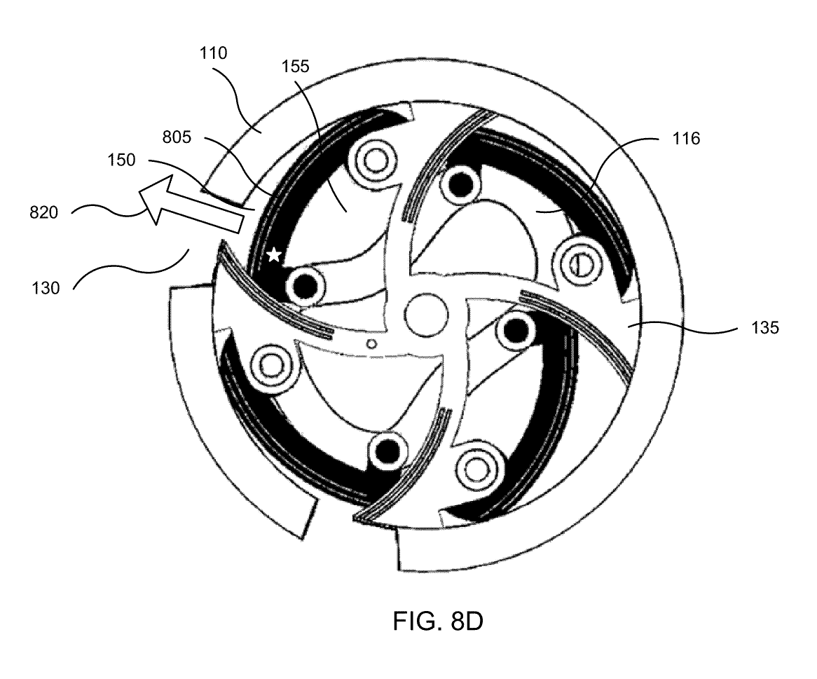

In this embodiment, the engine housing 110 is a cylindrical shell. The engine housing 110 extends longitudinally along an axis of the engine housing 110. The engine housing 110 houses the rotating components described above. The engine housing 110 may include, among others, an inner surface 111 and an outer surface 112. The inner surface 111 is cylindrical, and in some embodiments, the outer surface 112 may include features to mount the rotary wing engine 105 to a frame, for example, the frame of an automobile. In some embodiments, a sparkplug hole 120, an air intake 125, and an exhaust outlet 130 may be formed in the engine housing 110. The sparkplug hole 120 allows the sparkplug 121 to extend inside the rotary wing engine 105 to initiate a combustion, further described below in detail with reference to FIG. 8C. In some embodiments, the rotary wing engine 105 may utilize a two or more sparkplugs. The air intake 125 provides a path for air to flow into the rotary wing engine 105, further described in detail below with reference to FIG. 8A. The exhaust outlet 130 provides a path for combusted gases to flow out of the rotary wing engine 105, further described below in detail with reference to FIG. 8D. The engine housing 110 is described in detail with reference to FIGS. 2A through 2D.

The two end plates 115A and 115B are enclosing structures at both ends of the housing configured to enclose the rotor 135 and wing assemblies 145 within the engine housing 110. The end plates 115 may have the same outside diameter as the engine housing 110. The end plates 115 may be positioned to be concentric to the engine housing 110. The surface of each end plate 115 facing the engine housing 110 rests flush against the engine housing 110, forming an enclosed compartment comprising the engine housing 110 and the end plates 115.

One or both of end plates 115 may include a cam track 116. In some embodiments, the cam track 116 is a recessed groove formed in the flat surface of the end plate 115.

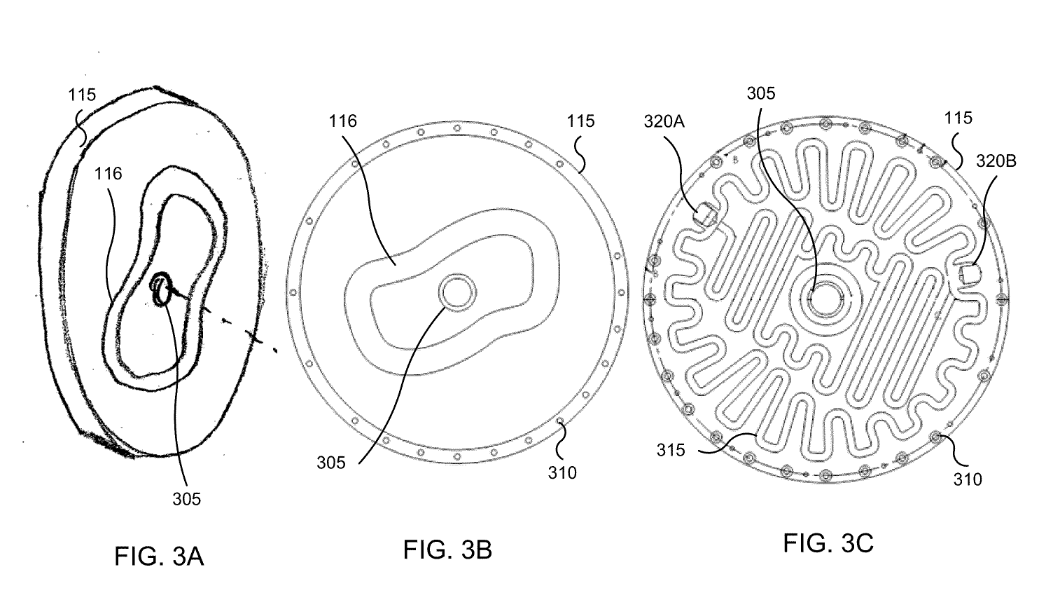

In this example embodiment, the end plates 115 are secured to the engine housing 110 by the use of threaded screws. In other embodiments, the end plates 115 may be secured to the engine housing 110 using a variety of other fasteners or adhesives. The end plates 115 are described in detail with reference to FIGS. 3A through 3C.

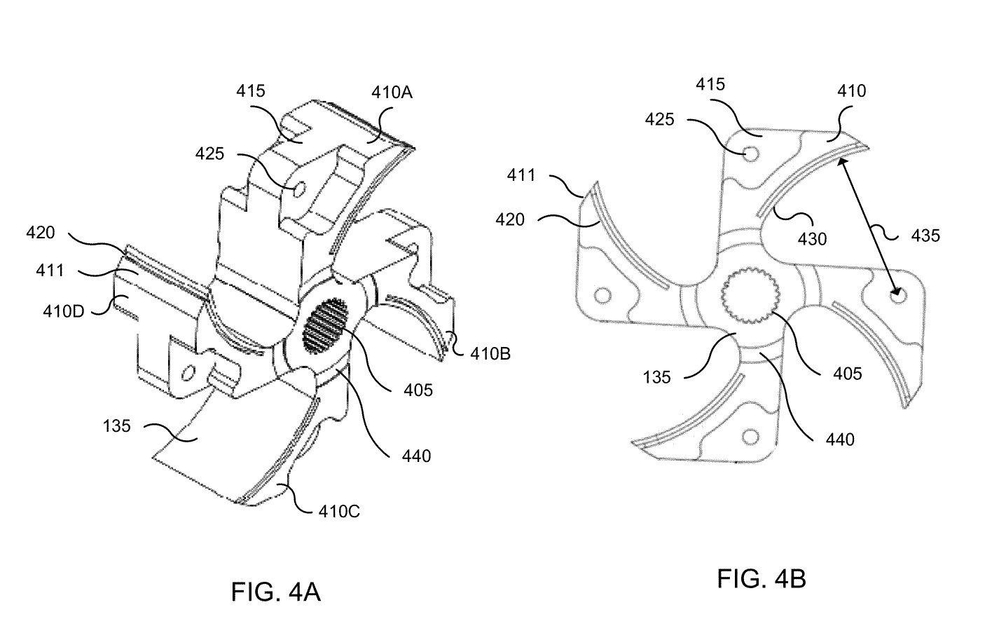

The rotor 135 comprises a plurality of arms 410 arranged such that they are radially symmetric, and the rotor 135 can rotate within the engine housing 110 about the axis of the engine housing 110. The arms 410 extend from the center of the rotor 135 to the inner surface 111 of the engine housing 110, as described below in detail with reference to FIGS. 4A and 4B. Each of the wing assemblies 145 is mounted to each of the arms 410 in such a way that the wing assembly 145 can rotate with reference to the rotor 135 about an axis parallel to the axis of the engine housing 110. A hole 405 is formed in the center of the rotor 135 so that the crankshaft 140 can extend through the hole 405, such that the axis of the crankshaft 140 is aligned with the axis of the engine housing 110, and the crankshaft 140 supports the rotor 135 within the engine housing 110. The structure of the rotor 135 is described in detail with reference to FIGS. 4A and 4B.

The crankshaft 140 is cylindrical in shape and has a length equal to or greater than the combined depth of the engine housing 110 and end plates 115. One or both ends of the crankshaft 140 extend through a hole 305 (shown in FIGS. 3A through 3C) in each end plate 115. The rotor 135 is secured to the crankshaft 140 using, for example, splines to transfer the rotation motion of the rotor 135 to the crankshaft 140. The rotational output of the rotary wing engine 105 may be transferred via the crankshaft 140 to an external device, such as the transmission of an automobile. In some embodiments, the crankshaft 140 may be splined to allow other components to be easily fixed to the crankshaft 140.

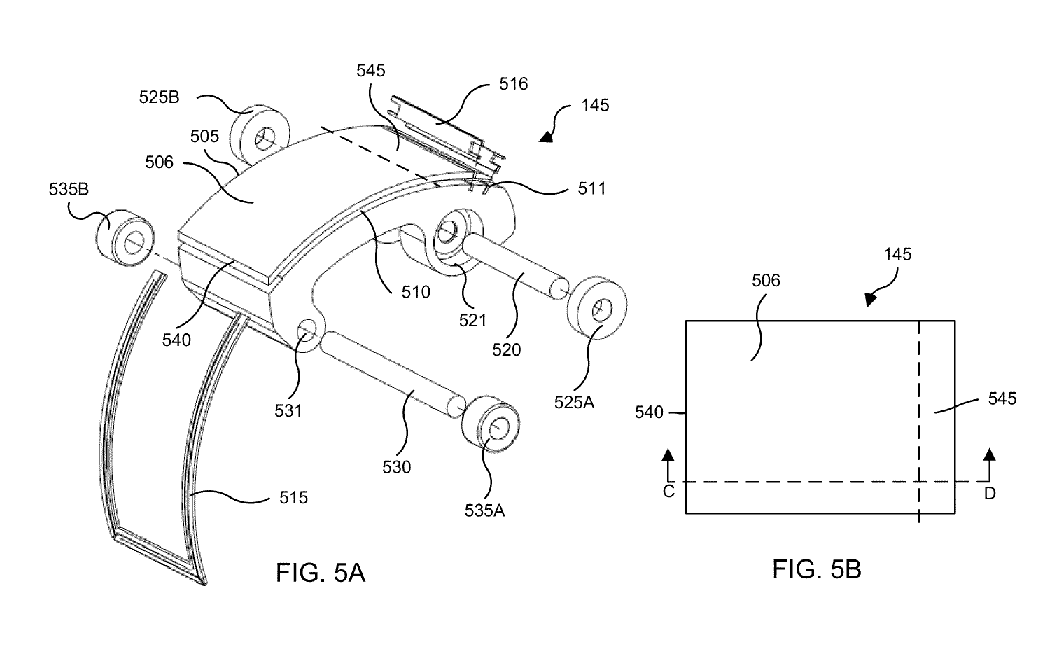

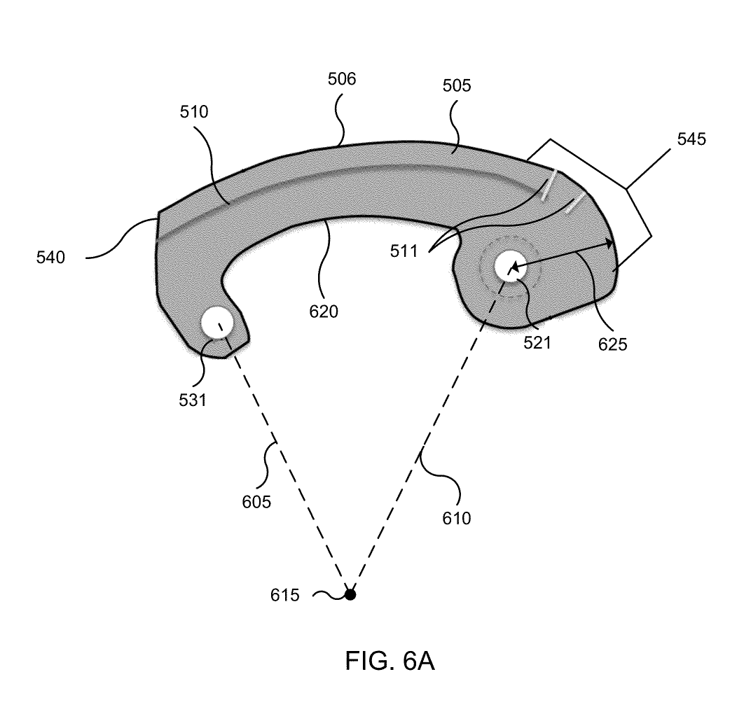

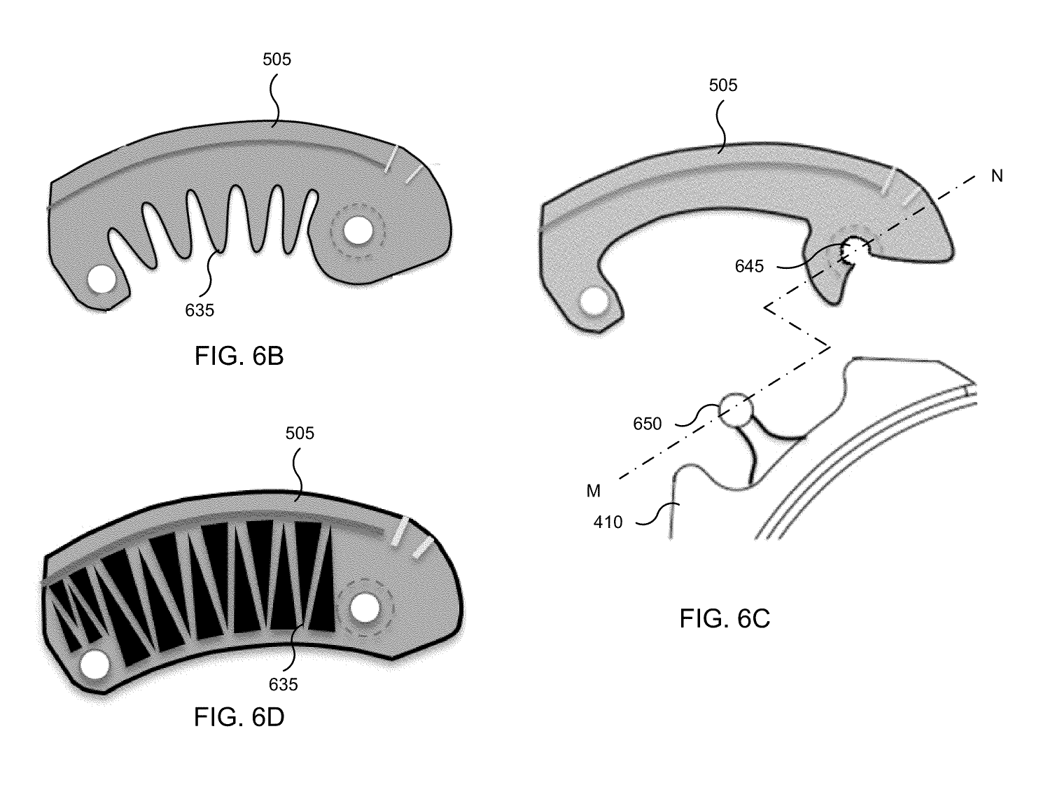

Each of the wing assemblies 145 is mounted to each of the arms 410 of the rotor 135. The wing assemblies 145 can rotate with reference to the rotor 135 about an axis that is parallel to the axis of the crankshaft 140. The wing assemblies 145 may include leading pin rollers 535A, 535B (shown in FIG. 4A) that fit into the cam track 116. In some embodiments, the leading pin rollers 535 may be ball bearings or roller bearings. As the rotor 135 rotates within the engine housing 110, the cam track 116 guides the leading pin rollers 535, causing the wing assemblies 145 to pivot with reference to the rotor 135. The wing assemblies 145 may be analogous to the pistons in a traditional piston-based internal combustion engine. The wing assemblies 145 are described in detail with reference to FIG. 5 and FIGS. 6A through 6D.

The sparkplug 121 is a device that emits a spark when a voltage difference is applied across two electrical terminals. Sparkplugs are well known in the related field and detailed description thereof is omitted herein for the sake of brevity. The sparkplug 121 is secured inside the sparkplug hole 120 such that the sparkplug 121 completely seals the sparkplug hole 120. In this example embodiment, the sparkplug 121 and sparkplug hole 120 are threaded, thus allowing the sparkplug 121 to screw into the sparkplug hole 120.

Generally, an internal combustion engine is well sealed such that the expanding gases from the combustive process can be efficiently converted into rotational motion. In a traditional piston-based internal combustion engine, a piston moves up and down within a cylinder. The cavity formed by the piston and cylinder is the combustion chamber in which a fuel is combusted. In order for the expanding gases from the combustion to efficiently move the piston within the cylinder, the piston forms a seal against the wall of the cylinder. In typical automotive designs, piston rings are used to seal the piston against the cylinder.

In some embodiments, a sealing structure 515, shown in FIG. 5A, is configured to isolate a first space between the inner surface 111 of the engine housing 110 and each of the wing assemblies 145. The first spaces are herein referred to as the plurality of first sealed chambers 150. In some embodiments, the sealing structure 515 is also configured to isolate a second space between each of the wing assemblies 145 and the rotor 135. The second spaces are herein referred to as the plurality of second sealed chambers 155.

In the depicted embodiment of the rotary wing engine 105, the engine housing 110, end plates 115, rotor 135, and wing assemblies 145 create a plurality of first sealed chambers 150. Each wing assembly 145 and a corresponding arm 410 isolate the first chambers 150 in conjunction with the inner surface 111 of the engine housing 110. Each wing assembly 145 and the rotor 135 also isolate a second chamber 155. Therefore, the rotor 135 and wing assemblies 145 may include seals that provide a seal against the engine housing 110 and end plates 115. The rotor 135 and wing assemblies 145 may also include seals that provide a seal against each other. The sealing mechanisms of the rotor 135 and wing assemblies 145 are described in detail below with reference to FIGS. 4, 5, and 7.

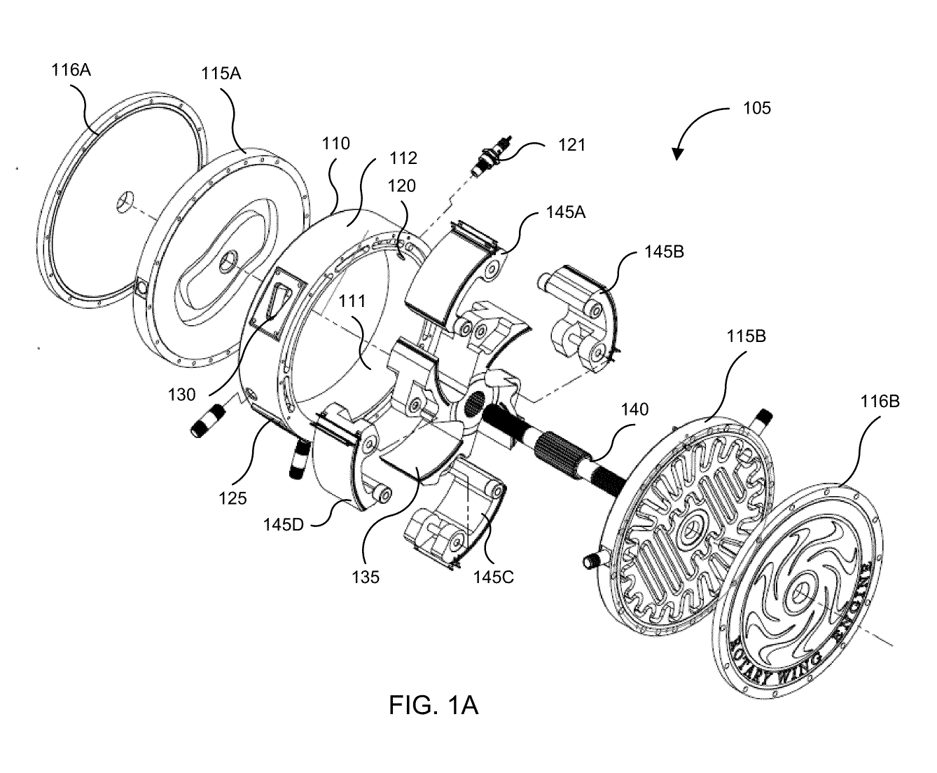

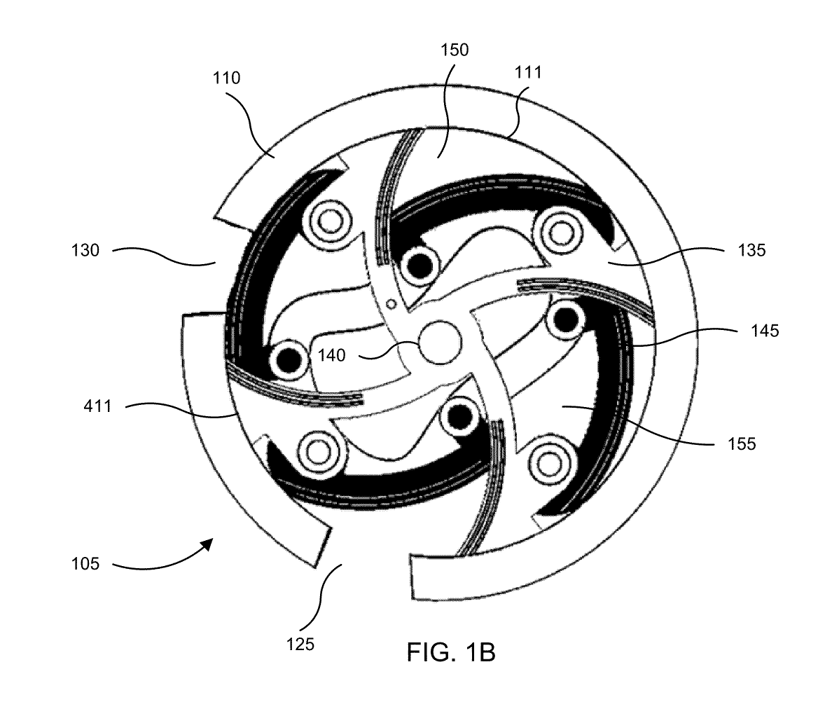

FIG. 1B illustrates a cross-sectional view of the embodiment of the rotary wing engine 105 depicted in FIG. 1A. The rotary wing engine 105 may include the engine housing 110, inner surface 111 of the engine housing 110, rotor 135, sealing edges 411 of the rotor 135, crankshaft 140, and wing assemblies 145. An air intake 125 and exhaust outlet 130 may be formed in the engine housing 110. As described above, the rotor 135 is housed within the engine housing 110.

The sealing edges 411 of the rotor 135 lie along the outside diameter of the rotor 135 and are positioned to be very close but not in contact with the inner surface 111 of the engine housing 110. The engine housing 110, end plates 115, rotor 135, and wing assemblies 145 form a plurality of first sealed chambers 150. The end plates 115, rotor 135, and wing assemblies 145 also form a plurality of second sealed chambers 155. Though the depicted embodiment of the rotary wing engine 105 includes a total of four wing assemblies 145, other embodiments may use more or fewer wing assemblies 145. Although the embodiment of FIG. 1B includes a sparkplug 121, other embodiments may use alternate combustion methods such as compression ignition.

FIG. 2A illustrates a perspective view of the engine housing 110 according to one embodiment. As described above with reference to FIG. 1A, the engine housing 110 extends longitudinally along an axis and is generally cylindrically shaped. The engine housing 110 houses the rotor 135, wing assemblies 145, and other components. The engine housing 110 may include, among others, an outer surface 112 and an inner surface 111. An air intake 125, an exhaust outlet 130, and a sparkplug hole 120 may be formed in the engine housing 110.

The sparkplug hole 120 allows the sparkplug 121 to extend inside the rotary wing engine 105 to initiate a combustion, further described in detail below with reference to FIG. 8C. The air intake 125 provides a path for air to flow into the rotary wing engine 105, further described below with reference to FIG. 8A. The exhaust outlet 130 provides a path for combusted gases to flow out of the rotary wing engine 105, further described in detail below with reference to FIG. 8D. In some embodiments, a plurality of grooves 122 may be formed in the inner surface 111 of the engine housing 110. The grooves 122 extend from the sparkplug hole 120 and direct the combustible gas to increase the efficiency of the combustion. In some embodiments, the engine housing 110 may be made of an aluminum alloy. In other embodiments, the engine housing 110 may be made of steel or various other metallic and non-metallic materials.

FIG. 2B illustrates a top-down view of the engine housing 110 according to one embodiment. FIG. 2C illustrates a cross-sectional view of the engine housing 110 taken along line A-B, according to one embodiment. In some embodiments, tubes 205 may be formed in the engine shell 110. In some embodiments, the tubes 205 have a circular cross-section. The tubes 205 may be configured to allow a fluid to circulate a cooling fluid throughout the engine shell 110 to aid in cooling the rotary wing engine 105. In some embodiments, a traditional 50/50 ratio of water and anti-freeze may be used as the cooling fluid. In other embodiments, alternative fluids may be used as the cooling fluid. In alternative embodiments, the tubes 205 may have different cross-sections to increase the surface area of contact between the cooling fluid and the engine housing 110. Increasing the surface area of contact between the cooling fluid and the engine housing 110 increases the efficiency at which the cooling fluid can cool the rotary wing engine 105.

FIG. 2D illustrates a cross-sectional view of the engine housing 110 with cooling fins, according to another embodiment. In some embodiments, the engine housing 110 may include cooling fins 210 that protrude outward from the outer surface 112 of the engine housing 110. The cooling fins 210 may aid in cooling the rotary wing engine 105 by increasing the surface area of the outer surface 112. Increasing the surface area of the outer surface 112 allows the rotary wing engine 105 to be cooled more effectively through convection with the surrounding air.

FIG. 2E illustrates a cross-sectional view of the engine housing 110, according to one embodiment. In some embodiments, tubes 215 may be formed in the engine housing 110. The tubes 215 may have a triangular cross-section, resulting in dividing walls 220 between each tube 215. The dividing walls 220, in conjunction with the inner surface 111 and outer surface 112, form a truss structure. The truss structure of the engine housing 110 is lightweight while maintaining structural integrity. The truss structure and its benefits are a well-known concept in the related field and will not be discussed in further detail. The triangular cross-section of the tubes 215 also increases the surface area of contact between the cooling fluid and the engine housing 110, compared to the circular tubes 205 depicted in FIG. 2C.

FIG. 3A illustrates a perspective view of the end plate 115 according to one embodiment. The end plate 115 is an enclosing structure and may be disc shaped with the same outside diameter as the engine housing 110. A cam track 116 may be formed in the end plate 115. In some embodiments, the cam track 116 is a recessed groove formed in the flat surface of the end plate 115. In some embodiments, a hole 305 may also be formed in the end plate 115. The crankshaft 140 may extend through the hole 305, allowing the crankshaft 140 to be connected to a driving mechanism, such as the transmission of an automobile. In alternative embodiments, the end plate 115 may not be disc shaped (e.g., square-shaped or elliptically shaped). In some embodiments, the crankshaft 140 may be supported in the hole 305 of the end plate 115 by a ball bearing to allow the crankshaft 140 to rotate smoothly. In some embodiments, the end plate 115 may be made of an aluminum alloy. In other embodiments, the end plate 115 may be made of steel or various other metallic and non-metallic materials.

FIG. 3B illustrates a front view of the end plate 115 according to one embodiment. As described with reference to FIG. 3A, a cam track 116 and a hole 305 may be formed in the end plate 115. Additionally, holes 310 may be formed in the end plate 115 to allow the end plate 115 to be secured to the engine housing 110. In some embodiments, screws are inserted through the holes 310 to secure the end plate 115 to the engine housing 110.

FIG. 3C illustrates a rear view of the end plate 115 according to one embodiment. In some embodiments, grooves 315 may be formed in the end plate 115. Additionally, coolant fluid ports 320A and 320B may be formed in the end plate 115. The grooves 315 may extend across the flat surface of the end plate 115, and may be configured to allow a cooling fluid to circulate through the end plate 115 to aid in cooling the rotary wing engine 105. The cooling fluid may be circulated through the grooves 315 by entering the grooves 315 through the coolant fluid port 320A and exiting the grooves 315 through the coolant fluid port 320B. The side covers 116 may seal against the end plate 115 to contain the cooling fluid within the grooves 315. In some embodiments, the grooves 315 may have a semi-circular cross section. In some embodiments, the grooves 315 in the end plate 115 may be part of a heat exchanger that exchanges heat between the cooling fluid flowing through the grooves 315 and the environment surrounding the rotary wing engine.

FIG. 4A illustrates a perspective view of the rotor 135 according to one embodiment. A hole 405 may be formed in the center of the rotor 135 to allow the crankshaft 140 to extend through the rotor 135. In some embodiments, the hole 405 may be splined to allow the rotor 135 to be fixed with reference to the crank shaft 140. The rotor 135 may include, among other structures, arms 410A, 410B, 410C, and 410D. Each arm 410 may further include, among others, a sealing edge 411 and a hinge protrusion 415. The arms 410 extend outward from the center of the rotor 135 and the sealing edge 411 of each arm contacts the inner surface 111 of the engine housing 110.

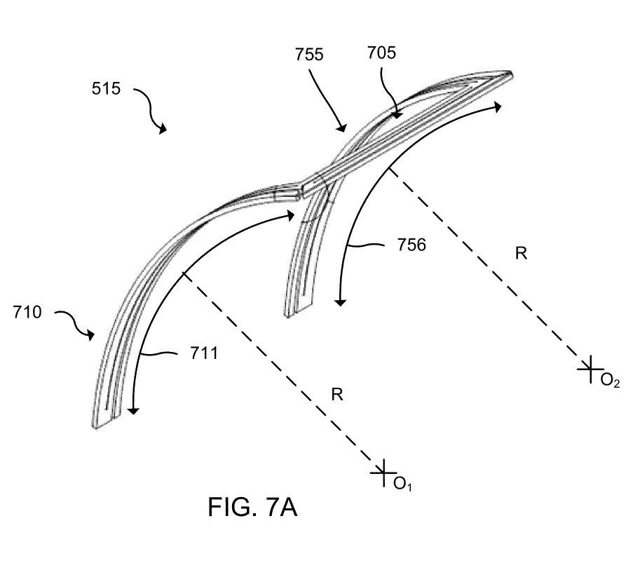

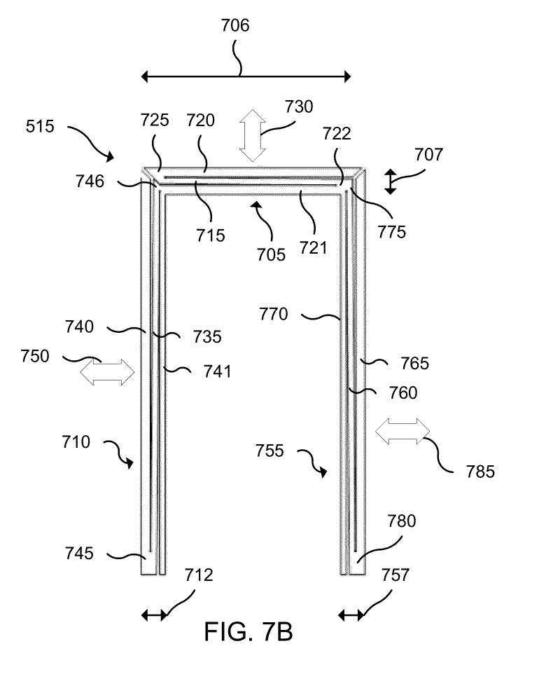

In some embodiments, a groove 440 may be formed in each arm 410. This groove may serve to allow air to flow between one second sealed chamber 155 to another second sealed chamber 155 as the second sealed chambers 155 increase or decrease in volume. In other embodiments, a hole may be formed in each arm 410 to allow air to flow between one second sealed chamber 155 to another second sealed chamber 155. In some embodiments, a pivot hole 425 may be formed in the hinge protrusion 415. In some embodiments, a seal groove 420 may be formed in each arm 410. A sealing structure 515 rests in the seal groove 420, further described below in detail with reference to FIG. 7A and 7B. In some embodiments, the rotor 135 may be made of an aluminum alloy. In other embodiments, the rotor 135 may be made of steel or various other metallic and non-metallic materials.

FIG. 4B illustrates a front view of the rotor 135 depicted in FIG. 4A, according to one embodiment. Each arm 410 may further include a curved surface 430 configured to abut the sealing structure of a corresponding wing assembly 145. For example, the curved surface 430 of the arm 410A is configured to abut the sealing structure 515 of the wing assembly 145 connected to the arm 410B. The curved surface 430 may have a radius of curvature 435 that corresponds to a distance from the axis of rotation of the wing assembly 145 to a leading edge 540 of the wing assembly 145, further described below in detail with reference to FIG. 6A. As the wing assembly 145 rotates about its axis of rotation, the sealing structure 515 of the wing assembly 145 slides along the curved surface 430.

FIG. 5A illustrates an exploded perspective view of the wing assembly 145 according to one embodiment. The wing assembly 145 may include, among other components, a wing 505, a single or plurality of sealing structures 515, trailing edge sealing structures 516, a hinge pin 520, bearings 525A and 525B, a leading pin 530, and leading pin rollers 535A and 535B. The wing 505 may further include an outer surface 506, a leading edge 540, and a trailing edge section 545.

The outer surface 506 may extend from the leading edge 540 to the trailing edge section 545 and may have a radius of curvature that is the same as the internal surface 111 of the engine housing 110. The outer surface 506 having the same radius of curvature as the internal surface 111 advantageously allows the wing 505 to more thoroughly compress the combustible gas during the compression step of the rotary wing engine 105, further described in detail below with reference to FIG. 8B. The outer surface 506 may define the first sealed chamber in conjunction with the curved surface 430 of the rotor 135 and the inner surface 111 of the engine housing 110.

The leading edge 540 may face a corresponding arm 410 of the rotor 135. A corresponding arm 410 of a wing herein refers to an arm of the rotor 135 that abuts the leading edge of the wing.

A seal groove 510 may be formed in the wing 505 to allow the sealing structure 515 to be secured to the wing 505, as described below in detail with reference to FIGS. 7A and 7B. Trailing edge seal grooves 511 may be formed in the trailing edge surface 545 of the wing 505 to allow the trailing edge sealing structures 516 to be secured to the wing 505. A hole 521 may be formed in the wing 505, adjacent to the trailing edge section 545, to allow the bearings 525 to fit securely in the hole 521. The hinge pin 520 extends through the first bearing 525A, the pivot hole 420 of the rotor 135, and the second bearing 525B to connect each wing assembly 145 to each arm 410 of the rotor 135. The axis of the hinge pin 520 corresponds to the axis about which each wing assembly 145 can rotate with reference to the rotor 135. For example, a wing assembly 145 may be connected to the arm 410B of the rotor 135 with the leading edge 540 of the wing assembly 145 facing the arm 410A. In some embodiments, a hole 531 may be formed in the wing 505. The leading pin 530 may extend through the first leading pin roller 535A, the hole 531, and the second leading pin roller 535B. The leading pin rollers 535 fit into the cam track 116 on each end plate 115.

In some embodiments, the cam track 116 constrains the rotation of the wing assemblies 145 with reference to the rotor 135 by guiding the leading pin rollers 535 along a path determined by the cam track 116 as the rotor 135 rotates within the engine housing 110.

In some embodiments, the cam track 116 is isolated from the first sealed chamber 150 during the ignition of the combustible gas during the operation of the rotary wing engine 105. In other words, the first sealed chamber 150 does not communicate with the cam track 116 during the power step of the operation of the rotary wing engine 105, further described below with reference to FIG. 8C. This prevents the combustible gas from escaping the first sealed chamber 150 once it has been ignited and allows the expansion of the combustible gas to exert a greater force on the wing assembly 145. The ignition of the combustible gas and the operation of the rotary wing engine 105 are further described in detail below in reference to FIGS. 8A through 8D.

In some embodiments, the various components of the wing assembly 145 may be made of an aluminum alloy. In other embodiments, the various components of the wing assembly 145 may be made of steel or various other metallic and non-metallic materials.

FIG. 5B illustrates a top-down view of the wing assembly 145 according to one embodiment. The wing assembly may include an outer surface 506, a leading edge 540, and a trailing edge section 545.

FIG. 6A illustrates a cross sectional view of the wing 505 taken along line C-D, according to one embodiment. The wing 505 may include, among others, an outer surface 506, a leading edge 540, a trailing edge section 545, an inner surface 620, and a distance 435. The inner surface 620 extends from the leading edge 540 to the trailing edge section 545. The inner surface 620 may define the second sealed chamber in conjunction with the rotor 135. The distance 435 extends from the axis of rotation of the wing assembly 145 to the leading edge 540.

In some embodiments, the trailing edge section 545 has a radius of curvature 625 that corresponds to the distance between the axis of the hinge pin 520 and the inner surface 111 of the engine housing 110. This allows the trailing edge section 545 of the wing 505 to remain in contact with the inner surface 111 of the engine housing 110 as the wing 505 rotates about the axis of the hinge pin 520 relative to the rotor 135. A seal groove 510, a hole 521, and a hole 531 may be formed in the wing 505. Trailing edge section seal grooves 511 may be formed in the wing 505 on the trailing edge section 545. The trailing edge section seal grooves 511 allow additional the trailing edge sealing structures 516 to be mounted to the wing 505 to seal the trailing edge section 545 of the wing 505 against the inner surface 111 of the engine housing 110. The trailing edge sealing structures 516 advantageously accommodate minor variations in the distance between the trailing edge section 545 and the inner surface 111 of the engine housing 110. The distance between the axis of the leading pin 530 and the axis of rotation 615 of the rotor 135 is represented by line 605. The distance between the axis of the hinge pin 520 and the axis of rotation 615 of the rotor 135 is represented by line 610. In some embodiments, the line 605 may be different from the line 610.

FIG. 6B illustrates a cross-sectional view of the wing 505 with cooling fins, according to another embodiment. The wing 505 may include, among other components, cooling fins 635 extending from the wing 505 into the second sealed chamber 155. In some embodiments, the cooling fins are roughly parabolic in shape. In other embodiments, the cooling fins may have more complex geometries. The cooling fins 625 increase the surface area of the inner surface 620 exposed to the second sealed chamber 155. In some embodiments, the increased surface area aids in the cooling of the wing 505 by dissipating heat from the wing 505 into the second sealed chamber 155.

FIG. 6C illustrates a cross-sectional view of the wing 505 and an alternative hinge mechanism, according to another embodiment. A groove 645 with a partially circular cross-section may be formed in the wing 505. In this embodiment, the arm 410 of the rotor 135 may include, among other components, a hinge pin protrusion 650 with a partially circular cross-section. The line M-N intersects both the axis of the groove 645 and the axis of the hinge pin protrusion 650. In some embodiments, the wing 505 is connected to the arm 410 of the rotor 135 with the axis of the groove 645 corresponding with the axis of the hinge pin protrusion 650 to allow the wing 505 to rotate about the axes with reference to the rotor 135. In some embodiments, the alternative hinge mechanism depicted in FIG. 6C allows the arm 410 and the wing 505 to have a more uniform cross-section. The more uniform cross-section allows for a more efficient manufacturing process through extrusion, as will be further described in detail below with reference to the Manufacturing Process section.

FIG. 6D illustrates a cross-sectional view of the wing 505 with a hollow interior according to one embodiment. Holes are formed within the wing 505 to form a truss structure 635. The truss structure of the wing 505 is lightweight while maintaining structural integrity. The truss structure and its benefits are a well-known concept in the related field and will not be discussed in further detail.

### Sealing Structure

FIG. 7A illustrates a perspective view of the sealing structure 515 according to one embodiment. In one embodiment, the sealing structure 515 may include, among others, a first member 705, a second member 710, and a third member 755. In some embodiments, the sealing structure 515 may be made of spring steel. In other embodiments, the sealing structure 515 may be made of various other metallic and non-metallic materials. The first member 705 has a radius of curvature R with respect to center O₁. Similarly, the third member 756 has a radius of curvature R with respect to center O₂.

FIG. 7B illustrates a front view of the sealing structure 515 according to one embodiment. The first member 705 extends across a first length 706 and has a first width 707 that is shorter than the first length 706. The second member 710 intersects with the first member 705 to form an angle with the first member 705. The second member 710 extends across a second length 711 and has a second width 712 that is shorter than the second length 711. The third member 755 also intersects with the first member 705 to form an angle with the first member 705. The third member 755 extends across a third length 756 and has a third width 757 that is shorter than the third length 756.

The first member 705 may further include, among other structures, three sub-members 715, 720, and 721. The three sub-members 715,720 and 721 are parallel and extend across the first length 706. Sub-member 715 and sub-member 720 are connected by bridge 725, and sub-member 720 and sub-member 721 are connected by bridge 722. The three sub-members 715, 720, and 721, in conjunction with bridges 722 and 725, form a double cantilever structure that provides resilience in the direction of the first width 707 of the first member 705, as indicated by the arrow 730. The second member 710 may further include, among other structures, three sub-members 735,740, and 741. The three sub-members 735,740 and 741 are parallel and extend across the second length 711. Sub-member 735 and sub-member 740 are connected by a bridge 745, and sub-member 725 and sub-member 741 are connected by a bridge 746. The three sub-members 735,740, and 741, in conjunction with bridges 745 and 746, form a double cantilever structure that provides resilience in the direction of the second width 712 of the second member 710, as indicated by the arrow 750. The third member 755 may further include, among other structures, three sub-members 760, 765, and 770. The three sub-members 760, 765, and 770 are parallel and extend across the third length 756. Sub-member 760 and sub-member 765 are connected by a bridge 775, and sub-member 760 and sub-member 770 are connected by a bridge 780. The three sub-members 760, 765, and 770, form a double cantilever structure that provides resilience in the direction of the third width 757, as indicated by arrow 785. In some embodiments, the second member 710 is curved in a direction perpendicular to the width of the second member 710. In some embodiments, the third member 755 is curved in a direction perpendicular to the width of the third member 755. In an alternative embodiment, the seal structure 515 may only include the first member 705 and the second member 710.

In some embodiments, the sealing structure 515 may be inserted into the seal groove 510 of the wing 505 so that the seal groove 515 receives sub-member 721 of the first member 705, sub-member 741 of the second member 710, and sub-member 770 of the third member 755. The sub-member 721 rests in the section of the seal groove 510 in the leading edge 540 of the wing 505. The second member 710 and third member 755 extend from the leading edge 540 to the trailing edge section 545, parallel to the outer surface 506, sub-members 741 and 770 resting in the sections of the seal groove 510 on either side of the wing 505. When the wing assembly 545 is connected to an arm 410 of the rotor 135, the first member 705 of the sealing structure 515 abuts the curved surface 430 of the corresponding arm 410 that the leading edge 540 faces, as described above in reference to FIG. 5A. For example, if a wing assembly 545 is connected to arm 410B, the leading edge 540 of the wing assembly 545 faces arm 410A. Accordingly, the first member 705 of the sealing structure 515 of the wing assembly 545 abuts the curved surface 430 of the arm 410A. Thus, the first member 705 of the sealing structure 515 seals the leading edge 540 of the wing 505 against the curved surface 430 of the corresponding arm 410 of the rotor 135. The resiliency of the first member 705 advantageously accommodates minor variations in the distance between the leading edge 540 and the curved surface 430. The second member 710 and the third member 755 advantageously seal the wing 505 against each end plate 115. The resilience of the second member 710 and third member 755 accommodate minor variations in the distance between the wing 505 and each end plate 115.

In some embodiments, a sealing structure including only the first member 705 of the sealing structure 515 may be inserted into the trailing edge section seal grooves 511 on the wing 505. This seals the trailing edge section of the wing 505 against the inner surface 111 of the engine housing 110 as the wing 505 rotates with reference to the rotor 135.

In some embodiments, the sealing structure 515 may also be inserted into the seal groove 420 on the arm 410 of the rotor 135. The first member 705 rests in the section of the seal groove 420 on the sealing edge 411 of the arm 410. The second member 710 and third member 755 extend from the sealing edge 411 towards the center of the rotor 135, parallel to the curved surface 430, resting in the sections of the seal groove 420 on either side of the arm 410. The first member 705 seals the sealing edge 411 against the inner surface 111 of the engine housing 110. The second member 710 and the third member 755 advantageously seal the arm 410 of the rotor 135 against each end plate 115. The resilience of the members of the sealing structure 515 accommodates minor variations in the distances between corresponding components. In other embodiments, a sealing structure similar to the sealing structure 515 may be inserted into the seal groove 420 of the rotor 135.

Referring back to FIG. 1B, a sealing structure 515 seals the wing assemblies 145 against the rotor 135 and each end plate 115. The sealing structures inserted into the trailing edge section seal grooves 511 seals the wing assemblies 145 against the inner surface 111 of the engine housing 110. Finally, the sealing structures 515 seals the rotor 135 against each end plate 115 and against the inner surface 111 of the engine housing 110. Thus, a plurality of first sealed chambers 150 is enclosed by the engine housing 110, end plates 115, rotor 135, and wing assemblies 145. Additionally, a plurality of second sealed chambers 155 is enclosed by the end plates 115, rotor 135, and wing assemblies 145.

### Operation of the Rotary Wing Engine

The operation of the rotary wing engine 105 will be described below with reference to FIGS. 8A through 8D. The description of the operation of the rotary wing engine 105 will refer specifically to one wing assembly 145 and the corresponding structures. However, the same principles of operation apply to each of the plurality of wing assemblies 145 and the corresponding structures. The particular wing assembly that will be described is wing assembly 805, marked with a star in FIGS. 8A through 8D. The wing assembly 805 may be similar to the wing assembly 145 described with reference to FIGS. 5A, 5B, and 6A through 6C. In some embodiments, the rotary wing engine 105 operates according to the principles of a four stroke engine. The steps of the four stroke engine may include intake, compression, power, and exhaust. The operational principles of a traditional four stroke engine are well known in the related field and thus are omitted herein for the sake of brevity.

FIG. 8A illustrates the intake step of a rotary wing engine 105 according to one embodiment. As the rotor 135 rotates counterclockwise with reference to the engine housing 110, the leading pin rollers 535 of the wing assembly 805 are guided by the cam track 116, and the wing assembly 805 rotates counterclockwise about the axis of the hinge pin 520. The volume of the first sealed chamber 150 increases and a combustible gas enters 810 the first sealed chamber 150 through the air intake 125. Simultaneous to the volume of the first sealed chamber 150 increasing, the volume of the second sealed chamber 155 decreases. In some embodiments, the combustible gas may be a mixture of air and fuel. In some embodiments, the air and fuel mixture may be supplied by a carburetor. In other embodiments, the fuel may be supplied separately through the use of direct fuel injection techniques.

FIG. 8B illustrates the compression step of the rotary wing engine 105 according to one embodiment. As the rotor 135 continues to rotate counterclockwise with reference to the engine housing 110, the leading pin rollers 535 of the wing assembly 805 are guided by the cam track 116, and the wing assembly 805 rotates clockwise about the axis of the hinge pin 520. The volume of the first sealed chamber 150 decreases, compressing the combustible gas within the first sealed chamber 150. Simultaneous to the volume of the first sealed chamber 150 decreasing, the volume of the second sealed chamber 155 increases.

FIG. 8C illustrates the power step of the rotary wing engine 105 according to one embodiment. Once the combustible gas within the first sealed chamber 150 has been sufficiently compressed, the combustible gas is ignited. The ignition of the compressed combustible gas causes the combustible gas to expand in volume. The expanding combustible gas exerts a force on the wing assembly 805, causing the wing assembly 805 to rotate counterclockwise about the axis of the hinge pin 520. Simultaneous to the wing assembly 805 rotating counterclockwise, the volume of the first sealed chamber 150 increases and the volume of the second sealed chamber 155 decreases. As the wing assembly 805 rotates counterclockwise, the leading pin rollers 535 are guided by the cam track, causing the rotor 135 to continue rotating counterclockwise with reference to the engine housing 110. In some embodiments, a sparkplug 121 may ignite the combustible gas. In other embodiments, compression ignition may be used. The rotary wing engine 105 generates a rotational force in the power step depicted in FIG. 8C.

FIG. 8D illustrates the exhaust step of the rotary wing engine 105 according to one embodiment. As the rotor 135 continues to rotate counterclockwise with reference to the engine housing 110, the leading pin rollers 535 of the wing assembly 805 are guided by the cam track 116, and the wing assembly 805 rotates clockwise about the axis of the hinge pin 520. The volume of the first sealed chamber 150 decreases, forcing 820 the ignited combustible gas to exit the first sealed chamber 155 through the exhaust outlet 130. Simultaneous to the volume of the first sealed chamber 150 decreasing, the volume of the second sealed chamber 155 increases.

Once the exhaust step of the operation of the rotary wing engine 105 is completed, the wing assembly 805 is positioned to begin the intake step of the rotary wing engine 105, and the rotor 135 continues to rotate counterclockwise. In reference to FIGS. 8A-8D, the trailing edge section 545 of the wing assembly 805 remains in contact with the internal surface 111 of the engine housing 110 as the wing assembly 805 rotates clockwise and counterclockwise. Likewise, the leading edge 540 of the wing assembly 805 slides along and remains in contact with the curved surface 430 of the corresponding arm 410 of the rotor 135.

The four steps of operation described with reference to wing assembly 805 apply to each of the wing assemblies 145, offset by one step. For example, as a first wing assembly undergoes the intake step depicted in FIG. 8A, a second wing assembly adjacent to the first wing assembly in the counterclockwise direction undergoes the compression step depicted in FIG. 8B.

The design of the rotary wing engine 105 is inherently balanced. As depicted in FIGS. 8A through 8D, the opposing wing assembles 145 move in opposite directions. For example, as the wing assembly 805 and its opposing wing assembly rotate counterclockwise, the leading edge 540 of both wing assemblies moves towards the axis of rotation of the rotor 135. Thus, the motion of any one wing assembly 145 is counterbalanced by the motion of the opposing wing assembly. This allows the rotary wing engine 105 to operate with significantly less vibration and noise than a traditional piston-based engine.

In some embodiments, a hole may be formed in each arm 410 of the rotor 135 extending from each second sealed chamber 155 to the adjacent second sealed chamber. These holes may allow air to flow freely between the plurality of second sealed chambers 155. In some embodiments, this air flow may decrease the force opposing the motion of each wing assembly 145. For example, as the wing assembly 805 and the opposing wing assembly rotate clockwise, the volume of the corresponding second sealed chambers increases. Simultaneously, the remaining two wings assemblies rotate counterclockwise, decreasing the volume of their corresponding second sealed chambers 150. The holes in the rotor 135 may allow air to flow from the decreasing second sealed chambers to the increasing second sealed chambers.

As is described with reference to FIGS. 8A through 8D, the air intake 125, exhaust outlet 130, and sparkplug 121 remain stationary with reference to the engine housing 110. In addition, only one air intake 125, exhaust outlet 130, and sparkplug 121 is provided for the operation of all four wing assemblies because the position of each wing assembly moves with reference to the engine housing 110. In contrast, each piston of a traditional piston-based internal combustion engine requires its own air intake, exhaust outlet, and sparkplug. This allows the design of the rotary wing engine to be more compact than a traditional piston-based internal combustion engine of equivalent displacements.

### Manufacturing Processes

Various components of the rotary wing engine 105 may be manufactured through an extrusion process. The uniform cross-sections of various components make the components particularly well-suited for manufacturing by extrusion. For example, the engine housing 110, the rotor 135, and wings 505 may be manufactured using an extrusion process. The details of the extrusion manufacturing process are well known in the related field and will not be described further.

In other embodiments, various components of the rotary wing engine 105 are manufactured through a combination of extrusion and traditional machining For example, the cylindrical form of the engine housing 110 may be extruded, and then the tubes 205 may be formed by machining.

Thus, while particular embodiments and applications have been illustrated and described, it is to be understood that the disclosed embodiments are not limited to the precise construction and components disclosed herein. Various modifications, changes and variations, may be made in the arrangement, operation and details of the method and apparatus disclosed herein without departing from the spirit and scope defined in the appended claims.

What is claimed is:

1. A rotary internal combustion engine comprising:
a housing extending longitudinally along a first axis, the housing comprising a cylindrical internal surface and formed with an intake port and an exhaust port;
a rotor positioned inside the housing to rotate about the first axis, the rotor comprising a plurality of arms extending to the cylindrical internal surface;
a plurality of wings, each of the wings attached to each of the arms to rotate with reference to the rotor along a second axis parallel to the first axis; and
a plurality of sealing structures, each of the sealing structures mounted onto each of the wings, the sealing structure configured to isolate a first space between the cylindrical internal surface and each of the wings from a second space between each of the wings and the rotor, combustible gas received in the first space through the intake port for ignition, and exhaust gas discharged from the first space through the exhaust port.

2. The rotary combustion engine of claim 1, further comprising enclosing structures at both ends of the housing and configured to enclose the rotor and the wings within the housing.

3. The rotary internal combustion engine of claim 2, wherein the enclosing structures comprise flat cylindrical end plates that are secured to each end of the housing.

4. The rotary internal combustion engine of claim 2, wherein tubes are formed within the shell and the enclosing structures, the tubes configured to circulate cooling fluid to cool the rotary combustion engine.

5. The rotary internal combustion engine of claim 1, wherein each arm of the rotor comprises a curved surface configured to abut the sealing structure of a corresponding wing, the curved surface having a radius of curvature corresponding to a distance from the second axis of the wing to a leading edge of the wing facing the surface, the sealing structure sliding along the curved surface.

6. The rotary internal combustion engine of claim 5, wherein each of the wings further comprises an outer surface extending from the leading edge, the outer surface having a radius of curvature the same as the internal cylindrical surface.

7. The rotary internal combustion engine of claim 5, wherein the sealing structure comprises:
a first member abutting the curved surface, the first member extending across a first length and having a first width shorter than the first length, the first member comprising:
a first sub-member extending across the first length,
a second sub-member extending across the first length in parallel to the first sub-member, and
a first bridge connecting the first sub-member and the second sub-member, the bridge in conjunction with the second sub-member forming a cantilever structure to provide resilience to the first member in a direction of the width of the first member; and
a second member intersecting with the first member to form an angle with respect to the first member, the second member having a second length and a second width shorter than the second length, the second member comprising:
a third sub-member extending across the second length,
a fourth sub-member extending across the second length in parallel to the third sub-member, and
a second bridge connecting the third sub-member and the fourth sub-member, the second bridge in conjunction with the fourth sub-member forming a cantilever structure to provide resilience to the second member in a direction of the width of the second member.

8. The rotary internal combustion engine of claim 1, further comprising a sparkplug extending through a sparkplug hole formed in the housing.

9. The rotary internal combustion engine of claim 8, wherein grooves are formed in the cylindrical internal surface of the shell extending from the sparkplug hole.

10. The rotary internal combustion engine of claim 1, wherein the housing further comprises a plurality of cooling fins extending outward from the housing.

11. The rotary internal combustion engine of claim 1, further comprising an enclosing structure attached to one end of the housing with the rotor and the wings enclosed in interior of the housing, a cam track formed in the enclosing structure to constrain the rotation of the wings with reference to the rotor as the rotor rotates about the first axis.

12. The rotary internal combustion engine of claim 11, wherein the cam track is isolated from the first space during the ignition of the combustible gas during the operation of the rotary internal combustion engine.

13. The rotary internal combustion engine of claim 1, wherein each of the wings further comprises:
a leading edge facing a corresponding arm of the rotor;
a trailing edge section hinged to another arm of the rotor adjacent to the corresponding wing;
an outer surface having a radius of curvature the same as the cylindrical inner surface of the shell and extending from the leading edge to the trailing edge section, the outer surface defining the first space in conjunction with the cylindrical internal surface; and
an inner surface extending from the leading edge to the trailing edge section, the inner surface defining the second space in conjunction with the rotor.

14. The rotary internal combustion engine of claim 13, wherein the trailing edge section comprises a trailing surface contacting the cylindrical internal surface, the trailing surface having a radius of curvature corresponding to a distance from the second axis to the cylindrical internal surface.

15. The rotary internal combustion engine of claim 1, wherein each of the housing, rotor, and the wings are manufactured using an extrusion process.

16. A sealing structure comprising:
a first member extending across a first length and having a first width shorter than the first length, the first member comprising:
a first sub-member extending across the first length, a second sub-member extending across the first length in parallel to the first sub-member, and
a first bridge connecting the first sub-member and the second sub-member, the bridge in conjunction with the second sub-member forming a cantilever structure to provide resilience to the first member in a direction of the width of the first member; and
a second member intersecting with the first member to form an angle with respect to the first member, the second member having a second length and a second width shorter than the second length, the second member comprising:
a third sub-member extending across the second length,
a fourth sub-member extending across the second length in parallel to the third sub-member, and
a second bridge connecting the third sub-member and the fourth sub-member, the second bridge in conjunction with the fourth sub-member forming a cantilever structure to provide resilience to the second member in a direction of the width of the second member.

17. The sealing structure of claim 16, wherein the second member comprises a fifth sub-member that is received in a groove formed in a wing of a rotary internal combustion engine.

18. The sealing structure of claim 16, wherein the second member is curved in a direction perpendicular to the width of the second member.

19. A method of operating a rotary internal combustion engine, comprising:
increasing a volume of a first space between a wing and an internal cylindrical surface of a housing to receive combustible gas in the first space by rotating a rotor about a first axis within a housing;
decreasing a volume of a second space between the wing and the rotor by rotating the wing about a second axis parallel to the first axis with the first space isolated from the second space by a sealing structure;
decreasing the volume of the first space to compress the received combustible gas;
igniting the combustible gas received in the first space to exert force on the wing and form exhaust gas, responsive to decreasing the volume of the first space;
increasing the volume of the first space responsive to igniting the combustible gas;
decreasing the volume of the first space by rotating the wing about the second axis to discharge the exhaust gas from the first space, responsive to igniting the combustible gas; and
increasing the volume of the second space by rotating the wing about the second axis with the first space isolated from the second space by the sealing structure.

20. The method of claim 19, further comprising maintaining contact between a trailing edge section of the wing and the internal cylindrical surface during the rotation of the wing about the second axis.
